(19) United States
(12) Patent Application Publication
(10) Pub. No.: US 2022/0188690 A1
(43) Pub. Date: Jun. 16, 2022

(54) MACHINE LEARNING SECURITY THREAT DETECTION USING A META-LEARNING MODEL

(71) Applicant: International Business Machines Corporation, Armonk, NY (US)

(72) Inventors: Ambrish Rawat, Dublin (IE); Hessel Tuinhof, Dublin 1 (IE); Killian Levacher, Dublin (IE); Stefano Braghin, Dublin (IE)

(21) Appl. No.: 17/118,648

(22) Filed: Dec. 11, 2020

(51) Int. Cl. G06N 20/00; G06K 9/62; H04L 29/06

(52) U.S. Cl. CPC G06N 20/00; H04L 63/1425; G06K 9/6256; G06K 9/628

(57) ABSTRACT

A computer-implemented method includes receiving at a threat detection system monitoring data in real-time from online activity in a network, the threat detection system including a machine learning model, and analyzing the monitoring data via the machine learning model to identify one or more anomalies in the monitoring data associated with a security threat to the network, the machine learning model trained to have one or more learning parameters. The method also includes receiving a subset of the monitoring data at a meta-learning module, storing the subset as time-based historical data, inputting the historical data at a meta-learning model, calculating an update policy prescribing a change to the one or more learning parameters based on the historical data, and applying the update policy to the machine learning model.

### BACKGROUND

The present invention generally relates to computing systems, and more specifically, to computing systems configured and arranged to identify security threats in a network using machine learning systems.

With the ubiquity of online activity, detection of anomalies in online data transmitted through networks is important in order to maintain speed and efficiency, as well as security. Intrusion or threat detection is relevant in many areas, including networking and cyber-security. Threat detection is also useful in contexts related to Internet of things (IoT) devices. Anomaly and intrusion detection typically includes logging events as log data. Events can be generated by firmware, operating systems, middleware, and applications. As computing systems have become more complex, the number of events (and consequently, the amount of log data) has increased significantly.

### SUMMARY

Embodiments of the present invention are directed to a computer-implemented method that includes receiving at a threat detection system monitoring data in real-time from online activity in a network, the threat detection system including a machine learning model, and analyzing the monitoring data via the machine learning model to identify one or more anomalies in the monitoring data associated with a security threat to the network, the machine learning model trained to have one or more learning parameters. The method also includes receiving a subset of the monitoring data at a meta-learning module, storing the subset as time-based historical data, inputting the historical data at a meta-learning model, calculating an update policy prescribing a change to the one or more learning parameters based on the historical data, and applying the update policy to the machine learning model.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of a processing system for monitoring network or online data and detecting anomalies associated with security threats, according to one or more embodiments of the invention;

FIG. 2 depicts a flow diagram representing a computer-implemented method of detecting anomalies in online operations based on monitoring data, using one or more machine learning models and a meta-learning model for defining and updating parameters associated with a machine learning process, according to one or more embodiments of the invention;

FIG. 3 depicts an example of the meta-learning model of FIG. 1, which is configured to calculate and update hyperparameters of a classification model, according to one or more embodiments of the invention;

FIG. 4 depicts another example of the meta-learning model of FIG. 1, which incorporates a hierarchy of individual models or sub-models for calculating or updating learning parameters in response to various types of events, according to one or more embodiments of the invention;

FIG. 5 depicts an exemplary computer system capable of implementing various aspects of the invention;

FIG. 6 depicts a cloud computing environment according to one or more embodiments of the invention; and

FIG. 7 depicts abstraction model layers according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments of the invention, the various elements illustrated in the figures are provided with two or three digit reference numbers.

### DETAILED DESCRIPTION

Systems, devices and methods are provided for detection of anomalies, security threats and/or vulnerabilities using artificial intelligence or machine learning techniques. A threat detection system in accordance with embodiments of the invention includes a threat detection pipeline or other threat detection system configured to receive monitoring data collected from online network activity, and analyze the monitoring data to detect anomalies in the monitoring data. The threat detection pipeline includes one or more machine learning elements, such as a classification model, which is trained and used to identify anomalies in the monitoring data. The threat detection pipeline may include various modules and/or other processing units to facilitate threat detection. For example, the threat detection pipeline includes a feature extractor and/or a clustering model.

The threat detection system also includes a meta-learning module configured to receive the monitoring data or subsets thereof, such as features extracted by the threat detection pipeline. The meta-learning module analyzes the monitoring data to estimate and/or update learning parameters that control the learning process of one or more machine learning elements in the pipeline. The meta-learning module includes, in one embodiment of the invention, a meta-learning model that calculates, on a continuous or periodic basis, learning parameters such as clustering parameters and/or hyperparameters. The meta-learning module compares the calculated learning parameters to learning parameters currently being used by the machine learning elements, and updates the machine learning elements in the pipeline if the calculated learning parameters are different than the current learning parameters. The meta-learning module allows for real time updating of hyperparameters and/or other learning parameters, to ensure that the pipeline is responding to the most relevant threats, and to improve adaptability of the threat detection pipeline to any scenario.

Embodiments of the invention present a number of technical benefits, including improved adaptability. In addition, the embodiments of the invention provide for automated design and deployment, as well as automatic updates to threat detection systems. Further, the meta-learning module can be easily introduced into existing systems, for example, as a plug-and-play module.

In many applications, log data acquired by detection systems is highly stochastic, and the distribution of anomalies changes with time. For such applications, it is important that the existing detection pipeline is able to quickly adapt and respond to novel anomalies. Traditional (offline) intrusion detection pipelines, which use machine learning elements trained offline, may have difficulty in quickly adapting to changes in threats. Embodiments of the invention provide a solution to this problem with the use of a meta-learning model that can be trained offline on historical data and be updated online to guide the detection process.

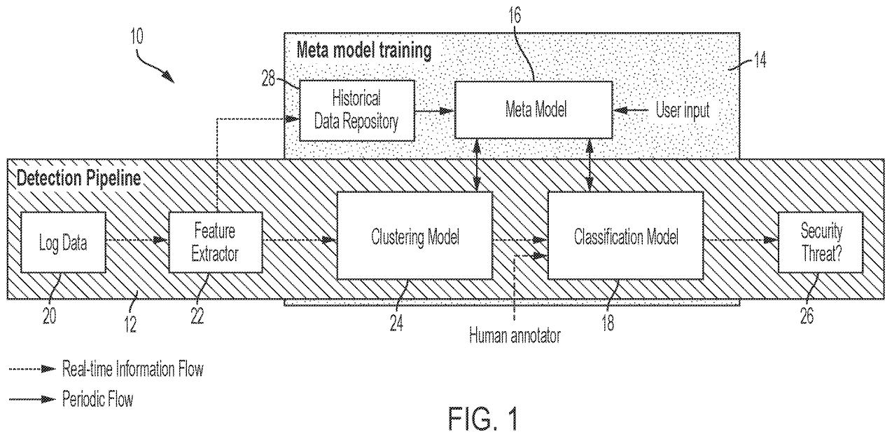

FIG. 1 depicts a threat detection system 10 according to embodiments of the invention. The threat detection system 10 may be deployed in any processing device, module or system that is in communication with a network, such as the Internet or a wide-area network. It is noted that the specific configuration and processing modules that can be used by the threat detection system 10 are not limited to the embodiments of the invention described herein.

The threat detection system 10 includes a detection pipeline 12 configured to acquire monitoring data (e.g., log data) in real time during online activity on a network, and determining based on the monitoring data whether a security threat exists. A “security threat” refers to any unauthorized or unexpected activity on a network, and may also be referred to as an “intrusion.” Examples of security threats include unauthorized network monitoring or use of the network by unauthorized entities (e.g., persons or programs), the presence of a virus, mal-ware or other programs, denial of service attacks, and others.

The system 10 can be utilized in conjunction with any processing device or system for which online threat detection is desired, and/or any device or system that utilizes machine learning. Examples include security products (e.g., anti-virus and other security programs), health systems, and Internet-of-things (IoT) devices and systems.

The system 10 includes a meta-learning module 14 that operates in parallel with the pipeline 12. The meta-learning module 14 is configured to receive real time monitoring data and/or user inputs, and provide updates to learning processes used by the threat detection pipeline 12. The meta-learning module 14 can provide continuous, periodic or discrete updates to the pipeline 12 during network use or activity, and thus operates in an online manner so that the pipeline 12 is promptly updated to detect any newly occurring threats.

The detection pipeline 12 includes one or more machine learning models that are used to analyze monitoring data and identify abnormalities and determine whether such abnormalities represent security threats. The machine learning model may include a supervised model, a reinforcement learning model, an unsupervised model, or any combination of one or more of such models. Examples of supervised models include regression models, decision trees, neural networks, Bayesian models, and classification models such as support vector machines (SVM) and others. Examples of unsupervised models include clustering models and feature extraction models.

The meta-learning module 14 includes at least one meta-learning model 16 for calculation and update of learning parameters. The meta-learning model 16 may be or include a representation of a machine learning model in the pipeline 12, i.e., may be a model of the machine learning model. For example, the meta-learning model 16 is a simplified version of one or more machine learning models in the pipeline 12. Generally, the meta-learning model 16 receives monitoring data or a subset thereof (e.g., extracted features as discussed below), and determines learning parameters that guide the learning process employed by the machine learning element(s) of the detection pipeline 12.

In one embodiment of the invention, the detection pipeline 12 includes one or more machine learning models. For example, as shown in FIG. 1, the detection pipeline includes a classification model 18. In one embodiment of the invention, the classification model 18 is a binary classification model that classifies data into one of two classes. For example, data can be classified in a “normal” classification or a “threat” classification. It is noted that the classification model 18 is not so limited, as the model may define any desired number of classes (e.g., classes for different types of anomalies).

The detection pipeline 12 includes an input module 20 for receiving real-time log data or other monitoring data, and may include a feature extractor 22 that analyzes the log data and selects and/or combines variables into features. A “feature” is any form of information or data of interest, such as location features (e.g., from IP addresses, user identifiers, etc.).

The detection pipeline 12, in one embodiment of the invention, includes a clustering model 24 that uses a data clustering algorithm to label the extracted features according to selected cluster dimensions. Examples of cluster dimensions include types of activities, such as logins to a network, accessing selected data types or locations, transmissions to or from selected locations, and others. The clustering model 24 may be used to assign tentative or “soft” labels. The classification model 18 may be trained using the extracted features and soft labels. The classification model 18 and/or the clustering model 24 may be, for example, a supervised learning model, a neural network, a decision tree or a deep learning model.

During online activity, the detection pipeline 12 receives real time monitoring data from a network, extracts features, clusters and labels the features, and inputs the features to the classification model 18. The classification model 18 classifies the features as belonging to a normal (benign) class, or a threat (malicious) class. A detection module 26 can receive classification information, and determine whether any of the monitoring data represents a security threat.

Also during the online activity, the meta-learning module 14 periodically or continuously (e.g., as monitoring data is received) updates the classification model 18 and/or the clustering model 24, by calculating learning parameters that guide the training of the models. For example, the meta-learning module 14 includes a data repository 28 that stores feature data in real time. The feature data is stored as time-dependent data (historical data) that provides a history of the feature data. The historical data is periodically input to the meta-learning model 16, which calculates learning parameters and updates the learning parameters if appropriate. For example, the meta-learning module 14 calculates clustering parameters of the clustering model 24 and/or calculates hyperparameters of the classification model 18, so that the models are updated as the network is used.

The meta-learning model 16 can be trained offline (i.e., independent of current network activity), and can also be trained online during network activity. Thus, training of the meta-learning model 16 may have an offline training phase and an online training phase. The offline training phase is performed by inputting, to the meta-learning model 16, current learning parameters of the clustering model 24 and/or the classification model 18. If the clustering model 24 and the classification model 18 are differentiable, input data can also include gradient information used during the training of the models. The meta-learning model 16 can be trained as a reinforcement controller, or trained as a supervised model, for example, as a regression model.

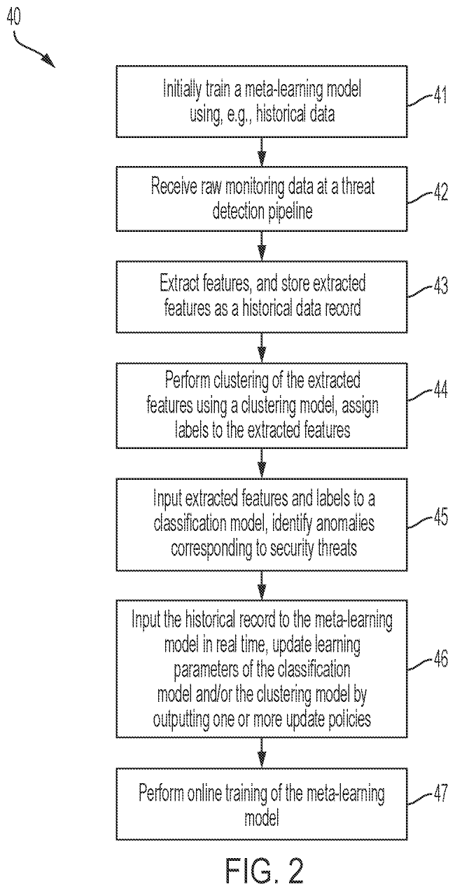

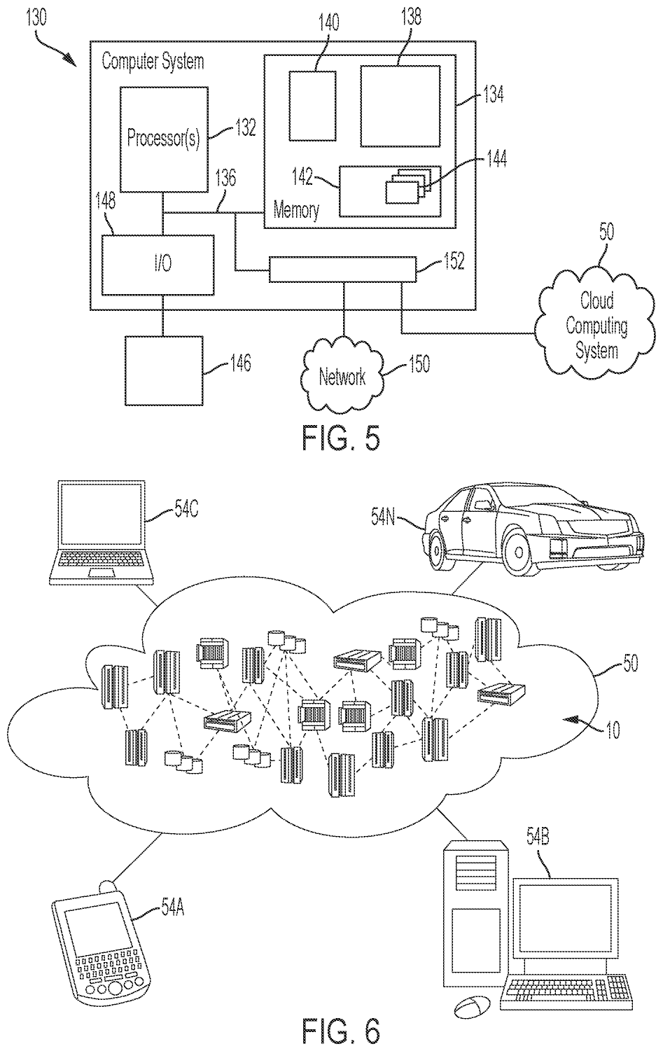

FIG. 2 is a flow diagram that depicts a computer-implemented method 40 of monitoring network data and detecting abnormalities and security threats in accordance with embodiments of the invention. The method 40 may be performed by a processor, OS or other suitable application or program in communication with a network. For example, the method 40 can be performed by aspects of the computer system and/or cloud computing environment shown in FIGS. 5-7.

The method 40 is discussed in conjunction with blocks 41-47. The method 40 is not limited to the number or order of steps therein, as some steps represented by blocks 41-47 may be performed in a different order than that described below, or fewer than all of the steps may be performed. For example, the steps represented by blocks 46 and 47 (updating via a meta-learning model and online training of a meta-learning model) may be performed in parallel with the steps represented by blocks 42-45 (identifying security threats).

It is noted that the method 40 is discussed in combination with the threat detection system 10, the threat detection pipeline 12 and the meta-learning module 14 of FIG. 1. However, the method 40 can be used with any threat detection system that utilizes machine learning or artificial intelligence to detect abnormalities or threats to a network.

At block 41, the meta-learning model 16 is initially trained offline according to the offline training phase discussed above. The meta-learning model 16 may be any machine learning model that can serve as a meta-model. For example, the meta-learning model 16 includes one or more deep learning models configured to use reinforcement learning.

At block 42, the processing device receives raw data from a network. The raw data may be, for example, sensor data from IoT devices, log data from servers, and/or financial transactions data. Examples of raw data include IP addresses, MAC addresses, user identifiers, security layer versions, and others.

At block 43, features are extracted from the raw data by the processing device by the feature extractor 22. Examples of features include geolocation features such as country, city, and postal code from IP addresses, and statistics (e.g., time and/or frequency of over data grouped by IP address or user identifier. Other examples of features include IP addresses used for login, and user identifiers associated with addresses (e.g., IP address/MAC address).

The extracted features are stored according to time, so that a historical record of the features is maintained. For example, the features are stored in the historical data repository 28.

At block 44, in one embodiment of the invention, a data clustering algorithm (e.g. DBSCAN) is performed on the features extracted from log data. This results in each feature being assigned a tentative or soft label corresponding to each of the cluster dimensions considered. For example, the algorithm can define clusters and group features in clusters associated with different types of activities (accessing an item on a network, login in from a mobile device, login in from a laptop, etc.). The cluster labels may optionally be verified or augmented by humans as representing malicious or benign datapoints.

At block 45, the extracted features and/or the labeled clusters are input to a classification model. Using hyperparameters provided by the meta-learning model 16, the classification model 18 (such as a SVM) is then trained using the extracted features and soft labels (and human annotations if applicable). The trained classification model 18 is then used to automatically determine whether each feature represents a security threat or not. For example, the classification model 18 classifies data as “malicious” or “benign.” The classifications are output to an output module 28 that provides a threat notification if features or data are detected that are classified as threats.

At block 46, the meta-learning model 16 is used is parallel with the detection pipeline 12 to continuously or periodically calculate the optimal hyperparameters to be used to train the classification model 18. The meta-learning model 16 may also be used to calculate learning parameters for the clustering model 24. Determination of hyperparameters and learning parameters is performed using model-based machine learning methods, based upon the changes detected within the evolution of input streams recorded within the historical data repository 28.

For example, the meta-learning model 16 periodically calculates hyperparameters for the classification model 18, and compares the calculated hyperparameters to current hyperparameters used to train the classification model 18. If the calculated and current hyperparameters are different, an update policy is generated to update to one or more hyperparameters of the classification model 18. An example of a hyperparameter is a learning rate for stochastic gradient descent (SGD) updates, if the classification model 18 is a neural network-based classifier.

The meta-learning model 16 may also periodically calculate learning parameters for the clustering model 24, compare the calculated learning parameters to current learning parameters used to train the clustering model 24, and provide an update policy to update the learning parameters. For example, an update policy can include a recommendation to increase or change the number of clusters to which the clustering model 24 can assign to monitoring data and/or extracted features.

At block 47, the meta-learning model 16 may be trained during online activity and in parallel with threat detection. When the system 10 is deployed, the meta-learning model 16 guides the update of classification and clustering models. Optionally, the performance of the deployed detection system can be used to further improve the meta-learning model 16 by updating its parameters with algorithms such as model-agnostic meta learning (MAML) algorithms. Such algorithms can employ techniques such as supervised learning and classification and regression to improve the functionality of the meta-learning model 16.

The meta-learning model 16 can be any type of machine learning or artificial intelligence model, which is capable of detecting changes in an input stream (e.g., detecting changes in extracted features), and updating classification and/or clustering models via learning parameter and/or hyperparameter updates. In one embodiment of the invention, the meta-learning model 16 accounts for different types of concept drifts, or changes in relationships between historical data input to a machine learning model, and outputs from the model. Concept drift can be sudden or gradual.

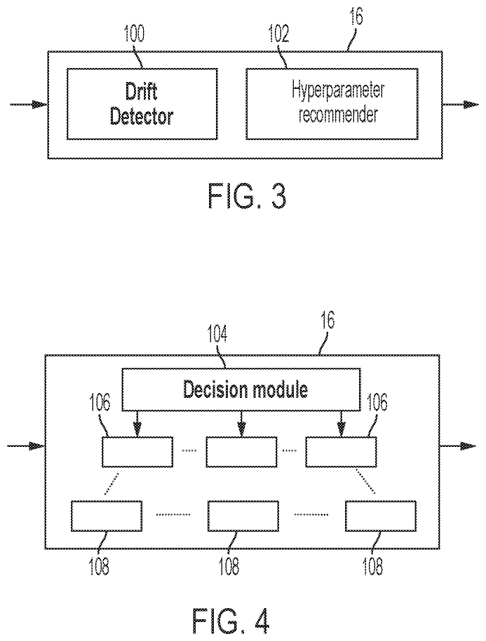

FIG. 3 depicts an example of the meta-learning model 16. In this example, the model 16 includes a drift detector 100 configured to detect various concept drifts. The drift detector 100 may be a deep neural network for capturing the drift in input data, or any other suitable model. The drift detector 100 outputs to a hyperparameter recommender 102 that provides an update policy to update hyperparameters based on concept drift, as well as other changes in monitoring data.

The meta-learning model 16 may be single model, or a combination of models or sub-models that can react to different triggers. An example of such a combination is shown in FIG. 4. In this example, the meta-learning model 16 includes a decision module 104 configured to determine the type of drift, and based on the type of drift, input feature data and/or monitoring data to one of multiple meta-models 106 configured to calculate parameters of the clustering model. The decision module 104 also inputs, based on the type of drift, to one of multiple meta-models 108 configured to calculate hyperparameters of the classification model 18.

FIG. 5 depicts an example of a computer system 130 that may be used to perform functions and implement various computer processing operations described herein. Components of the computer device 130 include one or more processors or processing units 132, a system memory 134, and a bus 136 that couples various system components including the system memory 134 to the one or more processing units 132. The system memory 134 may include a variety of computer system readable media. Such media can be any available media that is accessible by the one or more processing units 132, and includes both volatile and non-volatile media, removable and non-removable media.

For example, the system memory 134 includes a storage system 138 for reading from and writing to a non-removable, non-volatile memory 140 (e.g., a hard drive). It is noted that the storage system 18 is not so limited, and can be disposed within the system 130 and/or externally (e.g., in a database). The system memory 134 may also include volatile memory 142, such as random access memory (RAM) and/or cache memory. The computer system 130 can further include other removable/non-removable, volatile/non-volatile computer system storage media.

As will be further depicted and described below, the system memory 134 can include at least one program product having a set (e.g., at least one) of program modules that are configured to carry out the functions of embodiments of the invention.

For example, the system memory 134 stores an application 144 or components thereof. The application 144 may include one or more application programs, program modules, and/or program data. The application 144 may include detection pipeline components and/or meta-learning components. Program modules of the application 24 generally carry out the functions and/or methodologies of embodiments of the invention.

The one or more processing units 132 can also communicate with one or more external devices 146 such as a keyboard, a pointing device, a display, and/or any devices (e.g., network card, modem, etc.) that enable the one or more processing units 132 to communicate with one or more other computing devices. In addition, the one or more processing units 132 can communicate with an external storage device such as a database. Such communication can occur via Input/Output (I/O) interfaces 148. Other interfaces might include application programming interfaces (APIs) not shown here.

The one or more processing units 132 can also communicate with one or more networks 150 such as a local area network (LAN), a general wide area network (WAN), and/or a public network (e.g., the Internet) via network adapter 152. The processing units 132 can also communicate wirelessly via, for example, a Bluetooth connection or the like. It should be understood that although not shown, other hardware and/or software components could be used in conjunction with the computing system 130. Examples, include, but are not limited to microcode, device drivers, redundant processing units, external disk drive arrays, RAID systems, tape drives, and data archival storage systems, etc.

In some embodiments of the invention, the computer system 130 is connected to or part of one or more cloud computing systems 50. The cloud computing system 50 can supplement, support or replace some or all of the functionality (in any combination) of the computer system 130, including any and all computing systems described in this detailed description that can be implemented using the computer system 130. Additionally, some or all of the functionality described herein can be implemented as a node of the cloud computing system 50.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring to FIG. 6, illustrative cloud computing environment 50 is depicted. As shown, cloud computing environment 50 comprises one or more cloud computing nodes 52 with which local computing devices used by cloud consumers, such as, for example, personal digital assistant (PDA) or cellular telephone 54A, desktop computer 54B, laptop computer 54C, and/or automobile computer system 54N may communicate. Nodes 52 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 12 are intended to be illustrative only and that computing nodes 52 and cloud computing environment 50 can communicate with any type of computerized device over any type of network and/or network addressable connection (e.g., using a web browser).

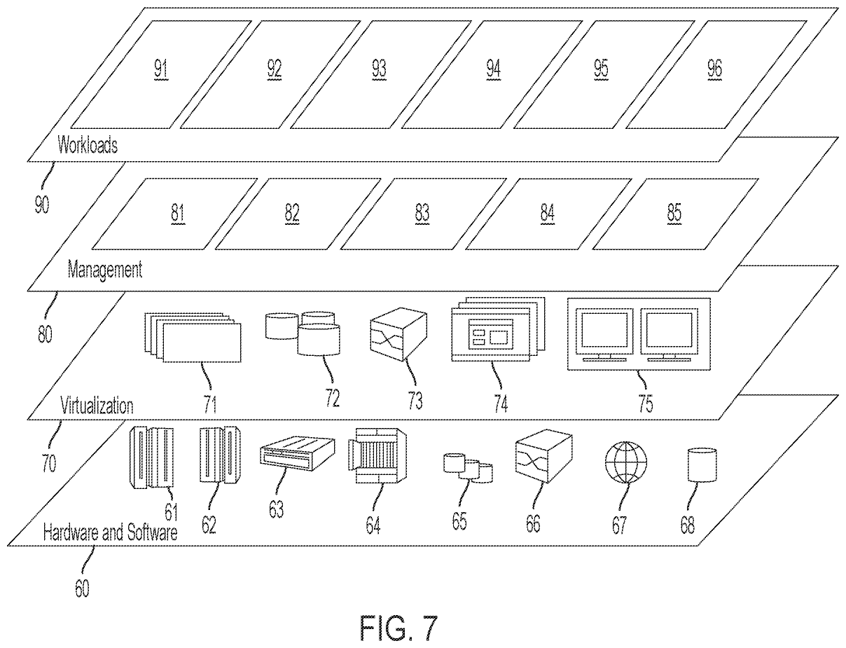

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and threat detection and meta-learning 96.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, a process, a method, an article, or an apparatus that comprises a list of elements is not necessarily limited to only those elements but can include other elements not expressly listed or inherent to such composition, mixture, process, method, article, or apparatus.

The terminology used herein is for the purpose of describing particular embodiments of the invention only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Additionally, the term “exemplary” and variations thereof are used herein to mean “serving as an example, instance or illustration.” Any embodiment or design described herein as “exemplary” is not necessarily to be construed as preferred or advantageous over other embodiments or designs. The terms “at least one,” “one or more,” and variations thereof, can include any integer number greater than or equal to one, i.e. one, two, three, four, etc. The terms “a plurality” and variations thereof can include any integer number greater than or equal to two, i.e., two, three, four, five, etc. The term “connection” and variations thereof can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The phrases “in signal communication”, “in communication with,” “communicatively coupled to,” and variations thereof can be used interchangeably herein and can refer to any coupling, connection, or interaction using electrical signals to exchange information or data, using any system, hardware, software, protocol, or format, regardless of whether the exchange occurs wirelessly or over a wired connection.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be understood that those skilled in the art, both now and in the future, may make various improvements and enhancements which fall within the scope of the claims which follow.

What is claimed is:

1. A computer-implemented method comprising:
receiving at a threat detection system monitoring data in real-time from online activity in a network, the threat detection system including a machine learning model;
analyzing the monitoring data via the machine learning model to identify one or more anomalies in the monitoring data associated with a security threat to the network, the machine learning model trained to have one or more learning parameters;
receiving a subset of the monitoring data at a meta-learning module, and storing the subset as time-based historical data;
inputting the historical data at a meta-learning model, and calculating an update policy prescribing a change to the one or more learning parameters based on the historical data; and
applying the update policy to the machine learning model.

2. The computer-implemented method of claim 1, wherein the meta-learning model includes a representation of the machine learning model.

3. The computer-implemented method of claim 1 further comprising extracting one or more features from the monitoring data, and storing the one or more features as part of the historical data in a data repository in communication with the meta-learning model.

4. The computer-implemented method of claim 1 further comprising training the meta-learning model offline prior to the online activity.

5. The computer-implemented method of claim 1, wherein the meta-learning model is used to calculate the update policy based on the historical data and user input.

6. The computer-implemented method of claim 1, wherein the machine learning model includes a classification model having at least one class associated with an anomaly, and the one or more learning parameters include one or more hyperparameters.

7. The computer-implemented method of claim 6, wherein the threat detection system includes a clustering model configured to label clustered monitoring data and input the labeled monitoring data to the classification model, the clustering model configured to, based on receiving a human annotation, label one or more clusters of the clustered monitoring data based on the human annotation, and the meta-learning module is configured to apply the update policy to the classification model and the clustering model.

8. The computer-implemented method of claim 1, wherein the machine learning model is selected from at least one of: a classification model and a clustering model.

9. A system comprising:
a memory comprising computer readable instructions; and
a processing device for executing the computer readable instructions for performing a method comprising:
receiving monitoring data in real-time from online activity in a network at a threat detection system, the threat detection system including a machine learning model;
analyzing the monitoring data via the machine learning model to identify one or more anomalies in the monitoring data associated with a security threat to the network, the machine learning model trained according to one or more learning parameters;
receiving a subset of the monitoring data at a meta-learning module, and storing the subset as time-based historical data;
inputting the historical data at a meta-learning model, and calculating an update policy prescribing a change to the one or more learning parameters based on the historical data; and
applying the update policy to the machine learning model.

10. The system of claim 9, wherein the meta-learning model includes a representation of the machine learning model.

11. The system of claim 9, wherein the method further comprises extracting one or more features from the monitoring data, and storing the one or more features as part of the historical data in a data repository in communication with the meta-learning model.

12. The system of claim 9, wherein the method further comprises training the meta-learning model offline prior to the online activity.

13. The system of claim 9, wherein the meta-learning model is used to calculate the update policy based on the historical data and user input.

14. The system of claim 9, wherein the machine learning model includes a classification model having at least one class associated with an anomaly, and the one or more learning parameters include one or more hyperparameters.

15. The system of claim 14, wherein the threat detection system includes a clustering model configured to label clustered monitoring data and input the labeled monitoring data to the classification model, the clustering model configured to, based on receiving a human annotation, label one or more clusters of the clustered monitoring data based on the human annotation, and the meta-learning module is configured to apply the update policy to the classification model and the clustering model.

16. A computer program product comprising:
a computer readable storage medium having program instructions embodied therewith, the program instructions executable by a processing device to cause the processing device to perform a method comprising:
receiving monitoring data in real-time from online activity in a network at a threat detection system, the threat detection system including a machine learning model;
analyzing the monitoring data via the machine learning model to identify one or more anomalies in the monitoring data associated with a security threat to the network, the machine learning model trained according to one or more learning parameters;
receiving a subset of the monitoring data at a meta-learning module, and storing the subset as time-based historical data;
inputting the historical data at a meta-learning model, and calculating an update policy prescribing a change to the one or more learning parameters based on the historical data; and
applying the update policy to the machine learning model.

17. The computer program product of claim 16, wherein the method further comprises extracting one or more features from the monitoring data, and storing the one or more features as part of the historical data in a data repository in communication with the meta-learning model.

18. The computer program product of claim 16, wherein the method further comprises training the meta-learning model offline prior to the online activity.

19. The computer program product of claim 16, wherein the machine learning model includes a classification model having at least one class associated with an anomaly.

20. The computer program product of claim 19, wherein the threat detection system includes a clustering model configured to label clustered monitoring data and input the labeled monitoring data to the classification model, the clustering model configured to, based on receiving a human annotation, label one or more clusters of the clustered monitoring data based on the human annotation, and the meta-learning module is configured to apply the update policy to the classification model and the clustering model.
